(19) United States
(12) Patent Application Publication
(10) Pub. No.: US 2014/0203562 A1
(43) Pub. Date: Jul. 24, 2014

(54) SYSTEM AND METHOD FOR CONTROLLING A WIND TURBINE INCLUDING CONROLLING YAW OR OTHER PARAMETERS

(71) Applicants: Nathaniel Black, Portland, OR (US); Michael Holder, Redmond, WA (US)

(72) Inventors: Nathaniel Black, Portland, OR (US); Michael Holder, Redmond, WA (US)

(73) Assignee: XZERES CORP., Wilsonville, OR (US)

(21) Appl. No.: 13/984,832

(22) PCT Filed: Feb. 10, 2012
(86) PCT No.: PCT/US12/24757

§ 371 Date: Mar. 14, 2014

Related U.S. Application Data
(60) Provisional application No. 61/442,135, filed on Feb. 11, 2011.
(60) Provisional application No. 61/442,136, filed on Feb. 11, 2011.

(51) Int. Cl. F03D 7/04; F03D 7/02

(52) U.S. Cl. CPC F03D 7/042; F03D 7/0204
USPC 290/44

(57) ABSTRACT

A system and method for controlling a wind turbine, including controlling yaw or other parameters. In accordance with an embodiment, each of several basic operating parameters of a wind turbine can be measured to provide turbine operating parameters, including both turbine current parameters and turbine operating extremes. Key operating parameters of the controller itself are also monitored. External/ambient measurement devices or sensors can be used to provide measurements about the environment as a whole, such as external/ambient wind data or other external data. The turbine operating parameters are used by the controller logic to calculate measured energy production. The external/ambient measurements are used by the controller logic to calculate estimated energy production. Comparing these indications provides useful feedback, such as diagnostics and/or efficiency; and/or can be used to control yaw or other parameters in a wind turbine.

### CLAIM OF PRIORITY

This application claims the benefit of priority to U.S. Provisional Patent Application No. 61/442,135, titled “CONTROLLER FOR USE WITH A WIND TURBINE”, filed Feb. 11, 2011; and U.S. Provisional Patent Application No. 61/442,136, titled “SYSTEM AND METHOD FOR CONTROLLING YAW OR OTHER PARAMETERS IN A WIND TURBINE”, filed Feb. 11, 2011, each of which applications are incorporated by reference herein.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

Embodiments of the invention are generally related to renewable energy systems and wind turbines, and are particularly related to a controller for use with a wind turbine; and a system and method for controlling yaw or other parameters in a wind turbine.

### BACKGROUND

Wind power refers to the conversion of wind into usable energy, such as electrical power or electricity, using a wind turbine. Generally, a wind turbine includes a plurality of blades attached to a rotor, which in turn is attached to a generator. As the blades (and rotor) are caused to rotate by incident wind, electrical power is generated.

Although many different designs exist, turbines can be classified as either horizontal axis wind turbines (HAWT) wherein the rotor is mounted horizontally, and vertical axis wind turbines (VAWT) wherein the rotor is mounted vertically. Larger turbines, and wind “farms” that may in some instances include hundreds of turbines, can be connected to a mainstream electrical grid and their output used to power large communities; while smaller wind turbines are particularly suited to providing local power in isolated locations, such as remote towns and farms. Across the spectrum of wind turbine design, technologies that allow turbines to make more optimal use of available wind and increase power output, can encourage the overall adoption of wind power, and contribute to a cleaner environment.

Typically, a turbine is operated using a controller, which controls how the turbine should be operated in particular wind conditions. For example, in a horizontal axis wind turbine the controller may use information about the current wind direction to rotate or yaw the turbine blades into the wind; or it may use information about the current wind speed to adjust the angle of the turbine blades for better performance at a lower wind speed, or reduced likelihood of damage at a higher wind speed.

Many controllers, particularly in smaller turbines, are mechanical in nature, and use current information from the turbine itself to control the operation of the turbine and the blades, including rotating the turbine blades into the incident wind. However, more sophisticated controllers could potentially provide more efficient operation of both new and existing turbine designs, and allow for more sophisticated control techniques. These are the general areas that embodiments of the invention are intended to address.

### SUMMARY

Disclosed herein is a controller for use with a wind turbine. In accordance with an embodiment, each of several basic operating parameters of the turbine can be measured to provide turbine operating parameters, including both turbine current parameters and turbine operating extremes. Key operating parameters of the controller itself are also monitored. External/ambient measurement devices or sensors can be used to provide measurements about the environment as a whole, such as external/ambient wind data or other external data. The turbine operating parameters are used by the controller logic to calculate measured energy production, i.e. an indication as to the current energy output of the turbine. The external/ambient measurements are used by the controller logic to calculate estimated energy production, i.e. an indication as to what energy output the turbine should produce in the current environmental conditions. Comparing these indications provides useful feedback, such as diagnostics and/or efficiency. In accordance with an embodiment, the controller can also use the information to automatically make adjustments or control the turbine. In accordance with an embodiment, the controller can include an embedded server that allows access over a local area network or the Internet and enables accessing all of the turbine's operating parameters and information and providing that information to other centralized servers that provide remote monitoring, maintenance and support services. Information from one or more turbines can be provided via a user interface such as a Web page.

Also disclosed herein is a system and method for controlling yaw or other parameters in a wind turbine. In accordance with an embodiment, each of several basic operating parameters of the turbine can be measured to provide turbine operating parameters, including both turbine current parameters and turbine operating extremes; while external/ambient measurement devices or sensors can be used to provide external/ambient measurements about the environment as a whole, such as external/ambient wind data or other external data. This information can be used to control yaw or other parameters in a wind turbine, in a more efficient manner. In accordance with an embodiment, the controller monitors the wind speed distribution over a sampling interval, and then performs a cost/benefit analysis to determine whether to perform the yaw adjustment.

### BRIEF DESCRIPTION OF THE FIGURES:

FIG. 1 shows an illustration of a wind turbine environment that includes a controller, in accordance with an embodiment.

FIG. 2 shows an illustration of a wind turbine controller, in accordance with an embodiment.

FIG. 3 shows a flowchart of a method for using a controller with a wind turbine, in accordance with an embodiment.

FIG. 4 shows an illustration of a yaw adjustment benefit model, in accordance with an embodiment.

FIG. 5 shows an illustration of an available power/yaw power analysis, in accordance with an embodiment.

FIG. 6 shows an illustration of a wind speed distribution histogram or chart, in accordance with an embodiment.

FIG. 7 shows an illustration of a wind turbine environment that allows for controlling yaw or other parameters, in accordance with an embodiment.

FIG. 8 shows a flowchart of a method for using a controller with a wind turbine, to control yaw or other parameters, in accordance with an embodiment.

### DETAILED DESCRIPTION

As described above, a typical turbine is operated using a controller, which controls how the turbine should be operated in particular wind conditions. Many controllers are largely mechanical in nature, and use information from the turbine itself to control the operation of the turbine and the blades, such as rotating or yawing the turbine blades into an incident wind. However, more sophisticated controllers could potentially provide more efficient operation of both new and existing turbine designs, and allow for more sophisticated or useful control techniques. To address this, described herein are various embodiments of a controller for use with a wind turbine. Also described herein are systems and methods for controlling yaw or other parameters in a wind turbine, in accordance with various embodiments.

### Wind Turbine Environment

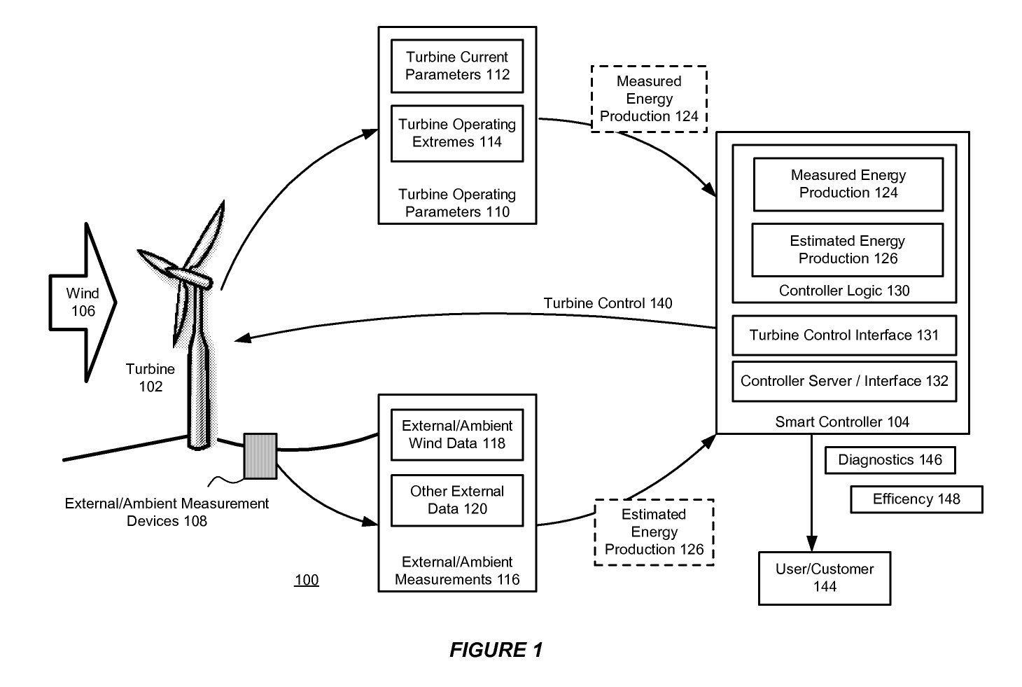

FIG. 1 shows an illustration of a wind turbine environment that includes a smart controller, in accordance with an embodiment. As shown in FIG. 1, the wind turbine environment 100 includes one or more turbines 102, each of which include or are associated with a smart controller 104. In accordance with an embodiment, each turbine includes its own dedicated smart controller, although in accordance with other embodiments one controller could be used to control a plurality of turbines.

During operation, the turbine converts available wind 106 into usable energy, such as electricity. As further shown in FIG. 1, the wind turbine environment includes one or more external/ambient measurement devices or sensors, which capture current information about the available wind and other conditions, separately from the turbine itself.

In accordance with an embodiment such external/ambient measurement devices or sensors can include, e.g. anemometers, wind vanes, and other environmental measurement devices.

In accordance with an embodiment, each of several basic operating parameters of the turbine can be measured to provide turbine operating parameters 110. These operating parameters can include both turbine current parameters 112 (e.g. the currently measured input voltage and current on each of the three alternator phases, alternator AC frequency, DC-Link voltage and current, current to each of the inverters, or other currently measured parameters); and turbine operating extremes 114 (e.g. the maximum measured alternator frequency, maximum DC Link voltage, maximum DC current, or other measured minima or maxima). In accordance with an embodiment, key operating parameters of the controller itself are also monitored.

In accordance with an embodiment, the external/ambient measurement devices or sensors can be used to provide external/ambient measurements 116 about the environment as a whole, such as external/ambient wind data 118 or other external data 120. To accomplish this, in accordance with an embodiment, the controller can include inputs for, e.g. external anemometers, wind vanes or other devices or sensors, to allow that information to be received into the controller.

The turbine operating parameters are used by the controller logic 130 to calculate measured energy production 124, i.e. an indication as to the current energy output of the turbine. The external/ambient measurements are used by the controller logic to calculate estimated energy production 126, i.e. an indication as to what energy output the turbine should produce in the current environmental conditions. Comparing these indications provides useful feedback, such as providing a way to answer a customer's questions about their energy production such as “I only produced 1000 kWh this month, and I think there is something wrong with my system—would you send somebody out?” In accordance with an embodiment, such diagnostics 146 and/or efficiency 148 information can be provided to a user/customer 144 (which may be an end user, or a central monitoring service), via a controller server/interface 132. In accordance with an embodiment, the controller can also use the information to automatically make adjustments or control the turbine 140, via a turbine control interface 131.

Controller for use with a Wind Turbine

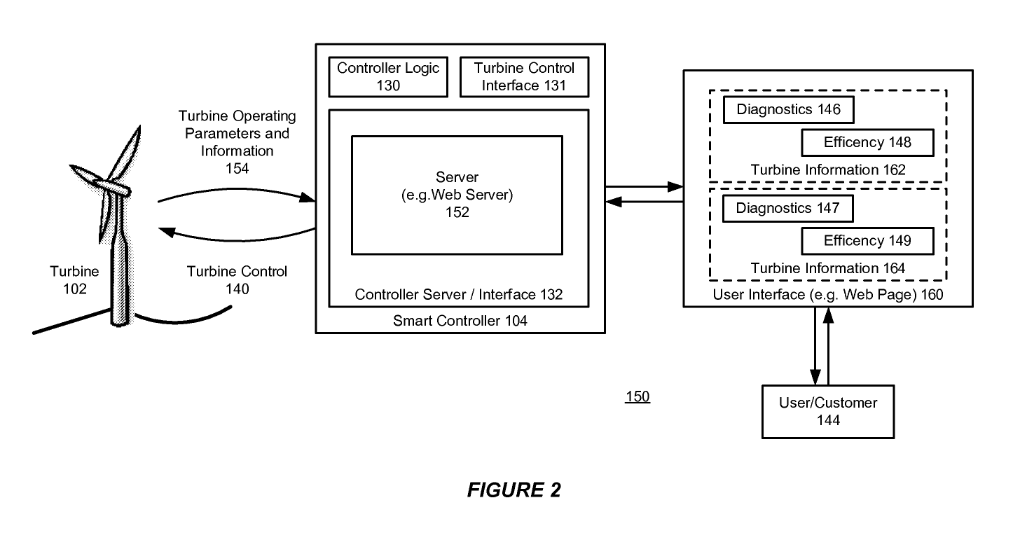

FIG. 2 shows an illustration 150 of a wind turbine controller, in accordance with an embodiment. As described above, in accordance with an embodiment, turbine diagnostics and/or efficiency information can be provided to a user/customer (which may be an end user, or a central monitoring service), via a controller server/interface. In accordance with an embodiment, the controller server/interface can include an embedded server (e.g. a Web server) 152, or other application software that allows access over a local area network or the Internet using, e.g. wireless technology, WiFi or GSM. The server enables accessing all of the turbine's operating parameters and information 154, and providing that information to other centralized servers that provide remote monitoring, maintenance and support services. In accordance with an embodiment, information from one or more turbines can be provided via a user interface 160, such as a Web page, that includes information such as diagnostics 146, 147 and efficiency 148, 149 information for each of several monitored turbines 162, 164.

In accordance with an embodiment, the controller logic and turbine control interface can be used in combination with the turbine's operating parameters and information to, e.g. test important and/or safety-related system components each time the turbine begins producing power, and then report the results of those tests. For example, in accordance with an embodiment, a sequence of tests can be performed that determine if the up-tower brake resistors are functioning properly, and that the diversion load is connected and functioning properly. These tests can be performed within the course of 2-3 seconds when the turbine starts spinning and the DC Bus voltage exceeds 90 volts. (It will be noted that this is not intended to function as a safety system per se, but rather as a verification that the existing/redundant safety systems function as intended). In accordance with an embodiment, the controller connects the up-tower brake resistors briefly and watches for an expected pattern of behaviors, and a balance between the 3 alternator phases, that indicate a proper function. The controller also conducts a similar test with the diversion load resistors, to assure that they are also functioning properly. In accordance with an embodiment, a key feature of the brake test is evaluating the proper functioning of the brake resistors, by measuring electrical signals, while the turbine is slowing down. During the period of such test the turbine speed may change due to changes in the wind (which can be addressed by making the test period 100 ms long) or because of the function of the brake. This latter aspect can be overcome by normalizing the measured amplitude of the alternator output to the AC Frequency. Since the unloaded alternator voltage is a function of its speed/frequency, the alternator voltage/frequency ratio is lowered by the load provided by the brake resistors. Measuring the change in the ratio when the brake is off versus on allows the system to accommodate the changing speed.

It will be evident that, while the above tests describe determining if the up-tower brake resistors are functioning properly, in accordance with various embodiments, other forms of testing can be performed, to provide additional information.

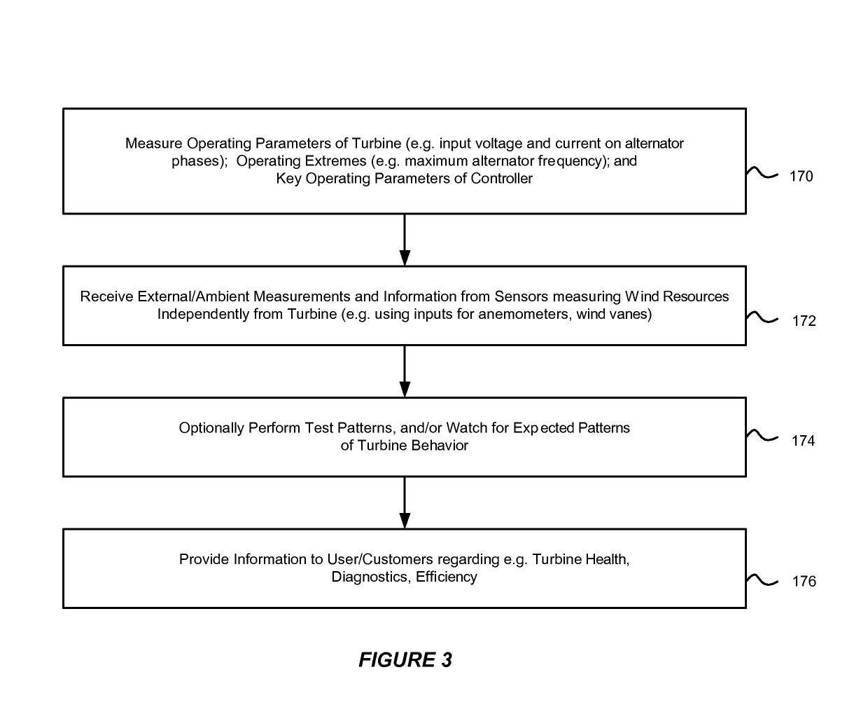

FIG. 3 shows a flowchart of a method for using a controller with a wind turbine, in accordance with an embodiment. As shown in FIG. 3, in step 170, the controller measures the operating parameters of the turbine (e.g. input voltage and current on alternator phases); the operating extremes (e.g. maximum alternator frequency); and the key operating parameters of controller itself. In step 172, the controller receives external/ambient measurements and information from sensors measuring wind resources independently from the turbine (e.g. using inputs for anemometers, wind vanes). In step 174, the controller optionally performs test patterns, and/or watches for expected patterns of turbine behavior. In step 176, the controller provides information to user/customers regarding e.g. turbine health, diagnostics, and efficiency.

### Control of Yaw or Other Parameters in a Wind Turbine

As described above, in accordance with an embodiment, each of several basic operating parameters of the turbine can be measured to provide turbine operating parameters, including both turbine current parameters and turbine operating extremes; while external/ambient measurement devices or sensors can be used to provide external/ambient measurements about the environment as a whole, such as external/ambient wind data or other external data.

In accordance with an embodiment this information can be used to control yaw or other parameters in a wind turbine, in a more efficient manner. In particular, in the case of larger wind turbines, these turbines do not automatically rotate or yaw their blades toward the wind, since doing so takes time, would likely not be optimal, and if performed too fast/frequently could result in damage to the turbine. Instead, adjusting the yaw of the turbine is a deterministic or controlled step, which itself takes some yaw power/cost to accomplish. As such, unless there is a reasonable expectation of improved output power, it may not be beneficial to perform the yaw adjustment. To address this, in accordance with an embodiment, the yaw adjustment is made only if the energy cost of the move is small enough, as a fraction of the energy benefit expected as a result, such that the desired efficiency goal is met.

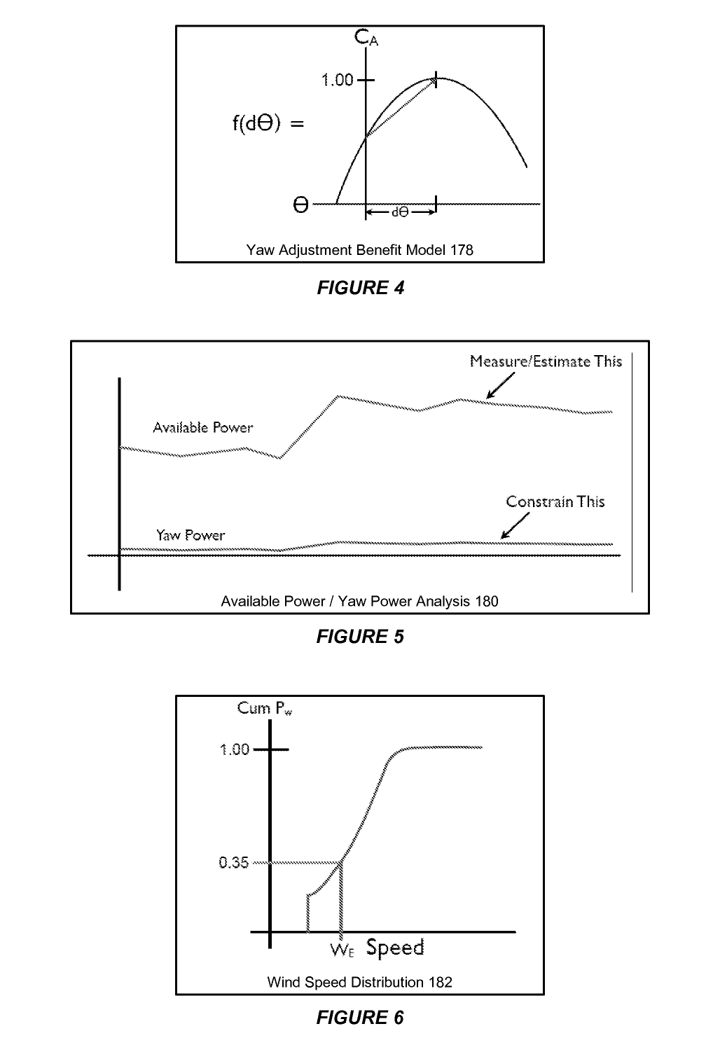

In accordance with an embodiment, the controller monitors the wind speed distribution over a sampling interval, and then performs a cost/benefit analysis to determine whether to perform the yaw adjustment. FIG. 4 shows an illustration of a yaw adjustment benefit model 178, in accordance with an embodiment. Such a model, curve or equivalent data allows the controller to determine a relative improvement from an adjustment, or “how much improvement can we expect from this yaw/move?”, which can be expressed as:

Cost Model=|d⊖|·kyaw

Expected Benefit=f(d⊖)·Future Production

where Kyaw is a coefficient for a particular turbine, and cost Model is the total cost required to yaw the particular turbine e degrees.

FIG. 5 shows an illustration of an available power/yaw cost power analysis 180, in accordance with an embodiment. In the case of a yaw adjustment, to meet the system's efficiency goal or target, the yaw power consumption, or yaw cost, should be less than some desired small percentage of the expected energy production. If the system determines there is no reasonable expectation of such improved output power, then it may not be beneficial to perform the yaw adjustment.

FIG. 6 shows an illustration of a wind speed distribution histogram or chart 182, in accordance with an embodiment. In accordance with an embodiment, the system integrates the measured wind speed distribution, truncated for required turbine cut-in, and uses this analysis to control the risk of an unproductive yaw adjustment.

In accordance with an embodiment, the system can integrate some small fraction of the Expected Benefit as a ‘bank’ of yaw energy credits. The system adjusts the yaw only when the credit content of the bank exceeds the cost of the move. The cost of each move is then deducted from the bank. Consumption of energy to yaw is limited by available-wind resource and efficiency target. Over time, the system controls the yaw in the most optimal manner for the environment as a whole.

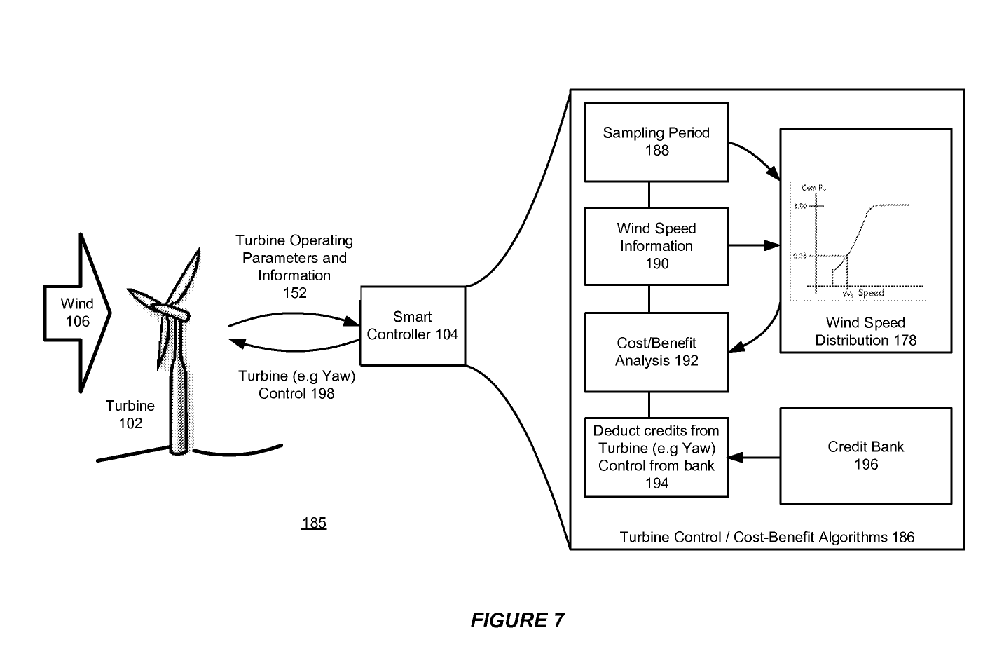

FIG. 7 shows an illustration of a wind turbine environment 185 that allows for controlling yaw or other parameters, in accordance with an embodiment. As shown in FIG. 7, in accordance with an embodiment, the controller measures the wind speed and direction continuously. Both the speed and direction are filtered to reduce the bandwidth to about 1 Hz. These filtered values are used by the controller as inputs to a turbine control/cost-benefit algorithm or similar process 186, as further described below:

In accordance with an embodiment, the algorithm operates over a recurring discrete sampling period 188 (e.g. 3-5 minutes). The system samples the wind speed at a particular sampling frequency (e.g. once per second) 190, and increments the wind speed histogram or chart 178 to characterize the distribution of wind speed. In accordance with an embodiment, the system can further filter the wind direction value to present an average value for the histogram sampling period. At the end of the sampling period, the wind-speed histogram is integrated, truncated below the turbine cut-in speed. The integral is normalized so that it spans a probability range from 0 to 1 over the range of measured wind speeds. This integral now represents a probabilistic estimate for the wind resource. The system then searches the integral to find the speed at which there is a certain confidence (not yet chosen, but likely 65-75%), if any, of a greater wind resource. This probable speed is the future expected resource.

In accordance with an embodiment, the system can calculate 192 the cost of a target move by subtracting the current yaw angle from the wind direction angle averaged over the sampling period. The system can then calculate the “benefit” factor as one-minus-the-Cosine of the move angle. The benefit function is truncated at zero for angles greater than 90 degrees. A “credit” is calculated from the probable speed by multiplying the expected turbine power for the probable speed by one minus the desired system efficiency (and probably another factor for other system losses) and the benefit factor. This credit will be zero if the probable speed is zero. In accordance with an embodiment, the credit is added to a “bank” of credits 196. The system then calculates the “cost” of the target move by multiplying a constant (not yet determined, based on the power required by the mechanism for moving the yaw) by the absolute value of the target move angle. If the bank is greater than the cost of the target move, the move is initiated and the cost deducted from the bank 194. If a move has already been initiated, the analysis is temporarily suspended until the move is completed. Then the system continues sampling and generating periodic evaluations of the cost to available banked credits.

It will be evident that, while the above cost-benefit algorithm describes measuring the wind speed and direction, and making determinations as to adjusting yaw, in accordance with various embodiments, other considerations can be taken into account in the algorithm, such as when to have the blade brake set, etc.

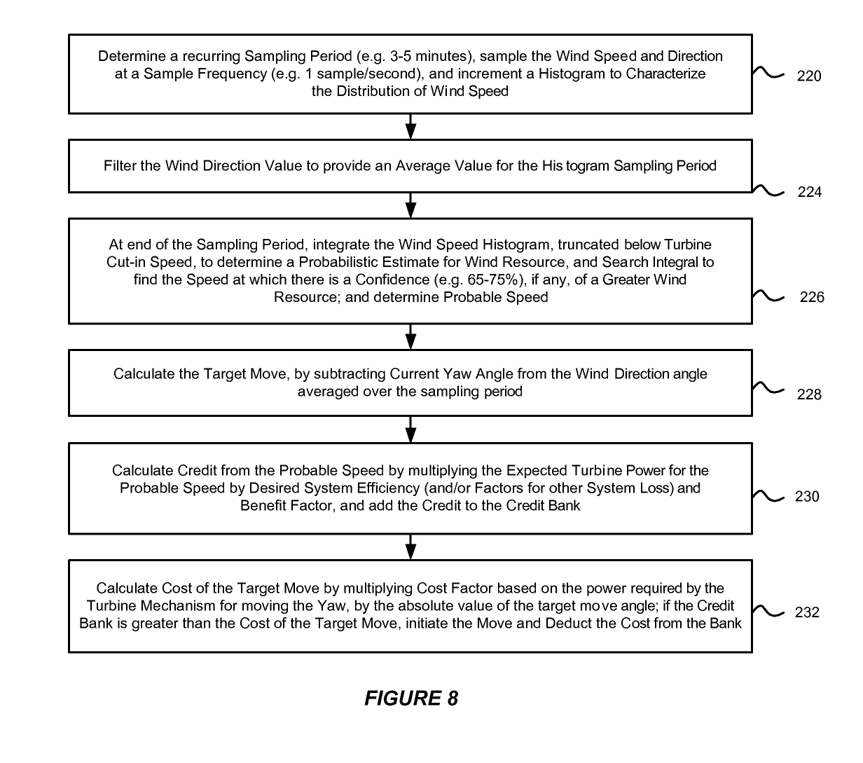

FIG. 8 shows a flowchart of a method for using a controller with a wind turbine, to control yaw or other parameters, in accordance with an embodiment. As shown in FIG. 8, in step 220, the system determines a recurring sampling period (e.g. 3-5 minutes), and samples the wind speed and direction at a sample frequency (e.g. 1 sample/second), and increments a histogram to characterize the distribution of wind speed. In step 224, the system filters the wind direction value to provide an average value for the histogram sampling period. In step 226, at the end of the sampling period, the system integrates the wind speed histogram, truncated below turbine cut-in speed, to determine a probabilistic estimate for wind resource, and search integral to find the speed at which there is a confidence (e.g. 65-75%), if any, of a greater wind resource; and determine probable speed. In step 228, the system calculates the target move, by subtracting current yaw angle from the wind direction angle averaged over the sampling period. In step 230, the system calculates a credit from the probable speed by multiplying the expected turbine power for the probable speed by desired system efficiency (and/or factors for other system loss) and benefit factor, and adds the credit to the credit bank. In step 232, the system calculate cost of the target move by multiplying cost factor based on the power required by the turbine mechanism for moving the yaw, by the absolute value of the target move angle. If the credit bank is greater than the cost of the target move, then the system initiates the move and deducts the cost from the bank.

The present invention may be conveniently implemented using one or more conventional general purpose or specialized digital computers or microprocessors programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of the present invention has been provided for the purposes of illustration and description. It is not intended to be exhaustive or to limit the invention to the precise forms disclosed. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A controller for use with a wind turbine, comprising:
a wind turbine environment, including a controller that allows each of several basic operating parameters of the turbine to be measured to provide turbine operating parameters, including both turbine current parameters and turbine operating extremes;
one or more external/ambient measurement devices or sensors that can be used to provide measurements about the environment as a whole, such as external/ambient wind data or other external data; and
wherein the turbine operating parameters are used by the controller logic to
calculate measured energy production or an indication as to the current energy output of the turbine, and
calculate estimated energy production or an indication as to what energy output the turbine should produce in the current environmental conditions, and
compare these indications to provide useful feedback such as diagnostics and/or efficiency regarding the turbine.

2. The controller of claim 1, wherein the controller includes an embedded server that allows access over a local area network or the Internet and enables accessing the turbine's operating parameters or other information, and providing that information to other servers for remote monitoring, maintenance and support services.

3. The controller of claim 1, wherein information from one or more turbines is provided via a user interface such as a Web page.

4. A method of controlling a wind turbine, comprising:
a wind turbine environment, including a controller that allows each of several basic operating parameters of the turbine to be measured to provide turbine operating parameters, including both turbine current parameters and turbine operating extremes;
one or more external/ambient measurement devices or sensors that can be used to provide measurements about the environment as a whole, such as external/ambient wind data or other external data; and
wherein the turbine operating parameters are used by the controller logic to
calculate measured energy production or an indication as to the current energy output of the turbine, and
calculate estimated energy production or an indication as to what energy output the turbine should produce in the current environmental conditions, and
compare these indications to provide useful feedback such as diagnostics and/or efficiency regarding the turbine.

5. The method of claim 4, wherein the controller includes an embedded server that allows access over a local area network or the Internet and enables accessing the turbine's operating parameters or other information, and providing that information to other servers for remote monitoring, maintenance and support services.

6. The method of claim 4, wherein information from one or more turbines is provided via a user interface such as a Web page.

7. A system for controlling yaw or other parameters in a wind turbine, comprising:
means for determining turbine operating parameters, including both turbine current parameters and turbine operating extremes, and external/ambient measurements about the environment as a whole; and
means for monitoring the wind speed distribution over a sampling interval, and then performing a cost/benefit analysis to determine whether to perform a turbine control, such as a yaw adjustment.

8. The system of claim 7, wherein the system includes a controller that allows each of several basic operating parameters of the turbine to be measured to provide turbine operating parameters, including both turbine current parameters and turbine operating extremes, and one or more external/ambient measurement devices or sensors that can be used to provide measurements about the environment as a whole, such as external/ambient wind data or other external data.

9. The system of claim 7, wherein the cost/benefit analysis includes use of a model that allows the system to determine a relative improvement from an adjustment, expressed as Cost Model=|d⊖|×Kyaw, and Expected Benefit=f(d⊖)×Future Production, wherein Kyaw is a coefficient for a particular turbine, and Cost Model is the total cost required to yaw the particular turbine ⊖ degrees.

10. A method of controlling yaw or other parameters in a wind turbine, comprising:
determining turbine operating parameters, including both turbine current parameters and turbine operating extremes, and external/ambient measurements about the environment as a whole; and
monitoring the wind speed distribution over a sampling interval, and then performing a cost/benefit analysis to determine whether to perform a turbine control, such as a yaw adjustment.

11. The method of claim 10, wherein the method includes using a controller that allows each of several basic operating parameters of the turbine to be measured to provide turbine operating parameters, including both turbine current parameters and turbine operating extremes, and using one or more external/ambient measurement devices or sensors that can be used to provide measurements about the environment as a whole, such as external/ambient wind data or other external data.

12. The method of claim 10, wherein the cost/benefit analysis includes use of a model that allows the system to determine a relative improvement from an adjustment, expressed as Cost Model=|d⊖|×Kyaw, and Expected Benefit=f(d⊖)×Future Production, wherein Kyaw is a coefficient for a particular turbine, and Cost Model is the total cost required to yaw the particular turbine ⊖ degrees.
